(19) United States
(12) Patent Application Publication
(10) Pub. No.: US 2010/0249445 A1
(43) Pub. Date: Sep. 30, 2010

(54) POST-SPIN-ON SILYLATION METHOD FOR HYDROPHOBIC AND HYDROFLUORIC ACID-RESISTANT POROUS SILICA FILMS

(75) Inventors: Yushan Yan, Riverside, CA (US); Christopher Lew, San Mateo, CA (US)

Correspondence Address: BUCHANAN, INGERSOLL & ROONEY PC, POST OFFICE BOX 1404, ALEXANDRIA, VA, 22313-1404, US

(73) Assignee: The Regents of the University of California, Oakland, CA (US)

(21) Appl. No.: 12/730,850

(22) Filed: Mar. 24, 2010

Related U.S. Application Data
(60) Provisional application No. 61/162,777, filed on Mar. 24, 2009.

(51) Int. Cl. C07F 7/02; B05D 1/40

(52) U.S. Cl. 556/466; 427/240

(57) ABSTRACT

A method of silylating porous silica films comprises: preparing a porous silica film; and grafting the film with a hydrophobic functional group while annealing the film. The porous silica film is a sol-gel silica film, a mesoporous silica film, in situ crystallized polycrystalline pure-silica zeolite (PSZ), spin-on PSZ, and spin-on PSZ MEL (or PSZ MEL-structural type) films. The hydrophobic functional group is trimethylchlorosilane (TMCS); dimethyldichlorosilane; methyltrichlorosilane; alkylchlorosilanes, such as (CH₃(CH₂)ₙ)ₓSiCl₄₋ₓ, where x is 1, 2, or 3; alkoxychlorosilanes; hexamethyldisilazane (HMDS), and/or aminosilanes. In addition, the steps of grafting and annealing the film are performed simultaneously, which imparts hydrofluoric acid resistance and reduces moisture adsorption to the film.

### CROSS-REFERENCE TO RELATED APPLICATION

This application claims priority to U.S. Provisional Patent Application Ser. No. 61/162,777, filed Mar. 24, 2009, which is incorporated herein by this reference in its entirety.

### FIELD OF THE INVENTION

The present invention relates to a post-spin-on silylation method for hydrophobic and hydrofluoric acid-resistant pure-silica-zeolite (PSZ) films, and more particularly to methods and processes for grafting of porous silica with hydrophobic functional groups during the film annealing process, which imparts HF-resistance to the material and reduces moisture adsorption.

### BACKGROUND

As the feature size of next-generation microprocessors decreases, the need for low-dielectric constant (low-k) materials with high mechanical strength is an increasing concern. For example, the intrinsic porous and crystalline nature of PSZs allows them to have many of the desired features necessary for a low-k material, especially strong mechanical strength. PSZ films contain terminal hydroxyl groups that easily bond with ambient water (k_{water}˜80), and this reaction increases the k value of PSZ films by 70% when they are exposed to ambient conditions (44% relative humidity). Furthermore, during the microprocessor manufacturing wet-etch processes, low-k materials are exposed to several corrosive chemicals that can undesirably etch the films. The terminal hydroxyl groups are possible reactive sites for corrosion and can thus promote deterioration of the films. The semiconductor industry tests the corrosion resistance of potential low-k materials by exposing them to hydrofluoric acid (HF). Five (5) minutes of HF etching resistance is considered to be the minimum by the semiconductor industry; PSZ films are etched in one (1) second or less.

Post-annealing silylation treatments with chlorotrimethylsilane, hexamethyldisilazane, as well as other silanes containing hydrophobic functional groups, and pure-silica-zeolite (PSZ) MFI has been functionalized with methyltrimethoxysilane, 3,3,3-trifluoropropyltrimethoxysilane, and 1H,1H,2H,2H-perfluorooctyltriethoxysilane through direct-synthesis methods. While post-annealing silylation techniques can reduce moisture adsorption, poor functionalization due to pore blocking and diffusion limitations still leaves PSZs prone to HF attack, and the presynthesis functionalization methods yield films with even less hydrophobicity.

It would be desirable in accordance with an exemplary embodiment, to have a method and system for grafting porous silicas with hydrophobic functional groups during the film annealing process, which imparts HF-resistance to the material and reduces moisture adsorption. It can be appreciated that by combining the silylation and annealing steps, these films become both hydrophobic and HF-resistant. In addition, this method and system does not require an extra post-annealing silylation step.

Accordingly, it can be appreciated that the mechanical properties of these functionalized films (reduced modulus as high as 19 GPa) are superior to those of the as-reported films (reduced modulus of approximately 10 GPa). As set forth below, the functionalized films have also been thoroughly characterized for chemical composition, k value, HF resistance, and mechanical integrity as set forth herein.

### SUMMARY

The present invention has been made in consideration of the above issues, and provides a method and system of silylating porous silica, including sol-gel silica, mesoporous silica, in situ crystallized polycrystalline PSZ, spin-on PSZ, and spin-on PSZ MEL (or PSZ MEL-structural type) films, which exhibit superior properties.

In accordance with an exemplary embodiment, a method of silylating porous silica films comprises: preparing a porous silica film; and grafting the film with a hydrophobic functional group while annealing the film.

In accordance with an exemplary embodiment, the porous silica film is a sol-gel silica film, a mesoporous silica film, and/or a zeolite spin-on film.

In accordance with a further exemplary embodiment, the hydrophobic functional group is trimethylchlorosilane (TMCS); dimethyldichlorosilane; methyltrichlorosilane; alkylchlorosilanes, such as (CH₃(CH₂)ₙ)ₓSiCl₄₋ₓ, where x is 1, 2, or 3; alkoxychlorosilanes; hexamethyldisilazane (HMDS), and/or aminosilanes.

In accordance with another exemplary embodiment, the steps of grafting and annealing the film are performed simultaneously, which imparts hydrofluoric acid resistance and reduces moisture adsorption to the film.

In accordance with a further exemplary embodiment, a method of silylating pure zeolite films comprises: preparing a pure zeolite film (PSZ) nanoparticle suspension, wherein the nanoparticle suspension is synthesized by: adding tetrabutylammonium hydroxide (TBAOH) to a silica source, such as tetraethylorthosilicate (TEOS), Ludox, and/or fumed silica, in a bottle with or without stirring; adding water; stirring the solution at room temperature or under heat for 0 to 10 days; moving the solution into a preheated convection oven between 50 and 100° C. with stirring for 1 to 5 days; transferring the solution to Teflon®-lined autoclaves; and placing the autoclaves into a preheated convection oven between 100 and 130° C. for 0.1 to 7 days with or without stirring; and grafting the film with a hydrophobic functional group while annealing the film.

It is to be understood that both the foregoing general description and the following detailed description are exemplary and explanatory and are intended to provide further explanation of the invention as claimed.

### BRIEF DESCRIPTION OF THE DRAWINGS

The accompanying drawings are included to provide a further understanding of the invention, and are incorporated in and constitute a part of this specification.

FIGS. 1(a)-1(c) show film thickness loss versus HF exposure time for (a) Trimethylchlorosilane (TMCS), Hexamethyldisilazane (HMDS), and Presilylated films, (b) Hexamethyldisilazane with TEOS—air baked (HTA) films, and (c) Hexamethyldisilazane with TEOS—N₂ baked (HTN) films.

FIGS. 2(a)-2(c) show IR spectra for (a) TMCS, HMDS, and Presilylated films, (b) HTA films, and (c) HTN films.

FIGS. 3(a)-3(b) show porosity and k versus TEOS concentration for (a) HTA films, and (b) HTN films.

### DETAILED DESCRIPTION

Reference will now be made in detail to the present preferred embodiments of the invention, examples of which are illustrated in the accompanying drawings and table.

As set forth above, a great number of materials have been proposed and studied as potential candidates for low-dielectric constant (low-k) materials, including some that demonstrated k values of 2 or lower. For example, two major classes of such materials are dense organic polymers and porous inorganic-based materials. Some dense organic polymers (e.g., highly fluorinated alkane derivatives such as polytetrafluoroethylene) may have sufficiently low k values, but they have the disadvantages of having relatively low thermal stability, thermal conductivity, and mechanical strength. In addition there is concern that they may react with conductor metals at elevated temperatures.

Among porous inorganic-based low-k materials, sol-gel silica has been studied and is commercially available, for example from Allied Signal or Honeywell under the trademark Nanoglass. It would be advantageous, in light of these developments, to provide method and system for producing low-k dielectric materials that can be applied as a thin film, has relatively small pores (most preferably <5 nm) and uniform pore distribution, with the necessary mechanical strength to be treated by chemical and mechanical polishing (CMP). Preferably, also, such films will have low hydrophilicity or can readily be modified to have low hydrophilicity, so that they would be relatively unaffected by the presence of moisture.

In accordance with an exemplary embodiment, this invention relates to the production and use of thin films of porous silica, such as sol-gel silicas, mesoporous silica and silica zeolites, prepared by in situ crystallization or by spin-on process, in integrated circuit and semiconductor assemblies or substrates, and for other uses as described herein.

In one aspect, this invention thus comprises providing a semiconductor device that comprises a semiconductor substrate, one or more metal layers or structures, and one or more dielectric films, wherein at least one dielectric film comprises a sol-gel, a mesoporous silica and/or a pure silica zeolite film.

By “semiconductor substrate” is meant substrates known to be useful in semiconductor devices, i.e. intended for use in the manufacture of semiconductor components, including, for instance, focal plane arrays, opto-electronic devices, photovoltaic cells, optical devices, transistor-like devices, 3-D devices, silicon-on-insulator devices, super lattice devices and the like. Semiconductor substrates include integrated circuits preferably in the wafer stage having one or more layers of wiring, as well as integrated circuits before the application of any metal wiring. Indeed, a semiconductor substrate can be as simple a device as the basic wafer used to prepare semiconductor devices. The most common such substrates used at this time are silicon and gallium arsenide.

It can be appreciated that the films of this invention may be applied to a plain wafer prior to the application of any metallization. Alternatively, they may be applied over a metal layer, or an oxide or nitride layer or the like as an interlevel dielectric, or as a top passivation coating to complete the formation of an integrated circuit.

It can be appreciated that typically, a mesoporous material is a material containing pores with diameters between 2 and 50 nm. Porous materials are classified into several kinds by their size. According to IUPAC notation, microporous materials have pore diameters of less than 2 nm and macroporous materials have pore diameters of greater than 50 nm; thus, the mesoporous category lies in the middle. Typical mesoporous materials include some kinds of silica and alumina that have similarly-sized fine mesopores. In accordance with an exemplary embodiment, mesoporous silica can be used in the method and systems as described herein.

Meanwhile, the sol-gel process, also known as chemical solution deposition, is a wet-chemical technique widely used in the fields of materials science and ceramic engineering. Such methods are used primarily for the fabrication of materials (typically a metal oxide) starting from a chemical solution which acts as the precursor for an integrated network (or gel) of either discrete particles or network polymers. Typical precursors are metal alkoxides and metal chlorides, which undergo various forms of hydrolysis and polycondensation reactions. The formation of a metal oxide involves connecting the metal centers with oxo (M-O-M) or hydroxo (M-OH-M) bridges, therefore generating metal-oxo or metal-hydroxo polymers in solution. Thus, the sol evolves towards the formation of a gel-like diphasic system containing both a liquid phase and solid phase whose morphologies range from discrete particles to continuous polymer networks. For example, in accordance with an exemplary embodiment, sol-gel silica can be used in the method and systems as described herein.

The term “silica zeolites” refers to zeolites having only or substantially only silicon and oxygen, and very little or no aluminum or other metals typically found in zeolites. For the purposes of this invention, silica zeolites can contain minor amounts of aluminum or other metals, that is, amounts that do not adversely affect the properties or performance of the resulting films. Silica zeolites of this type are generally referred to as “high-silica zeolites”. However, it is preferred that pure-silica zeolites are used in this invention. “Pure-silica zeolites” are silica zeolites having only silicon and virtually no aluminum or other metals. One type of pure-silica zeolite preferred for use in this invention, known as silicalite, is described in Flanigen, et al., Nature, 271, 512 (1978). Other silica zeolites that may be used in this invention include MEL, BEA, MCM-22, and MTW. Silica zeolites suitable for use in this invention may be produced either using starting materials containing only silicon and no metals, or may be produced by demetallation, particularly dealumination, of zeolites that contain aluminum or other metals.

It can be appreciated that zeolites in general are microporous crystalline materials with generally uniform molecular-sized pores that have been described in general as having low theoretical dielectric constants [e.g., Haw, et al., Nature 1997, 389, 832 and van Santen, et al., Chem. Rev. 1995, 95, 637.]. Their pore size (<2 nm) is significantly smaller than sizes of typical features of integrated circuits.

It can be appreciated that sol-gel matrices containing encapsulated organic molecules, and in particular, biomolecules, can be prepared by hydrolysis and condensation of an orthosilicate such as tetramethyl orthosilicate (TMOS) or tetraethyl orthosilicate (TEOS). In accordance with an exemplary embodiment, first, TMOS is partially hydrolyzed in an acidic medium by addition of a controlled amount of water. Next, the biological species is introduced in a suitable buffer to facilitate gelation. The buffer pH is chosen so as to allow the final solution to be close to neutrality in order to avoid denaturation of proteins. However, use of TMOS (or TEOS) as starting material leads to generation of alcohol (e.g., methanol or ethanol), the presence of which in large quantities can be deleterious to biomolecules, such as proteins and cells. In low temperature aging typically used with encapsulation of biological species, the generation of alcohol proceeds for an extended period of time allowing the encapsulated species to denature over time.

In accordance with an exemplary embodiment, a method and system for grafting porous silicas including sol-gel silica film, a mesoporous silica film and a zeolite spin-on film, with hydrophobic functional groups during the film annealing process, which imparts hydrofluoric acid-resistance (HF-resistance) to the material and reduces moisture adsorption is disclosed herein. It can be appreciated that by combining the silylation and annealing steps, these films become both hydrophobic and HF-resistant. In addition, in accordance with an additional embodiment, the method and system as set forth herein does not require an extra post-annealing silylation step. For example, when these films are exposed to ambient conditions, the effect of moisture uptake on the k value is virtually non-existent and k values are stable at about 1.5-2.7. In addition, when exposed to HF, these functionalized films can resist HF etching up to 30 minutes.

In accordance with an exemplary embodiment, the present invention relates to a post-spin-on silylation method for hydrophobic and hydrofluoric acid-resistant pure-silica-zeolite films, and more particularly to methods and processes for grafting of porous silica with hydrophobic functional groups during the film annealing process, which imparts HF-resistance to the material and reduces moisture adsorption. In accordance with an exemplary embodiment, the steps of grafting and annealing the film are performed simultaneously, which imparts hydrofluoric acid resistance and reduces moisture adsorption to the film.

In accordance with an exemplary, the porous silica film is a sol-gel silica film, a mesoporous silica film, and/or a zeolite spin-on film. It can be appreciated that the porous silica film can be a zeolite structural type, such as MFI, MEL, FAU, LTA, TSC, OBW, or BEA. In accordance with an exemplary embodiment, the porous silica film is a pure-silica zeolite (PSZ) nanoparticle suspension, which is prepared by synthesizing tetrabutylammonium hydroxide, tetraethylorthosilicate, and double-deionized water. The suspension can be prepared by adding a solvent, such as 1-butanol, to the nanoparticle suspension and spinning the suspension onto the substrate.

In accordance with an exemplary embodiment, the hydrophobic functional group can be trimethylchlorosilane (TMCS); dimethyldichlorosilane; methyltrichlorosilane; alkylchlorosilanes, such as (CH₃(CH₂)ₙ)ₓSiCl₄₋ₓ, where x is 1, 2, or 3; alkoxychlorosilanes; hexamethyldisilazane (HMDS), and/or aminosilanes.

In accordance with another exemplary embodiment, the PSZ nanoparticle suspension film can be placed in a furnace at a temperature between 0 and 600 degrees Celsius, and flowing a carrier gas through a bubbler at room temperature containing a solvent, such as toluene, and the silylating agent. In accordance with an exemplary embodiment, the carrier gas can be nitrogen, argon, and/or helium. It can be appreciated that in accordance with an exemplary embodiment, the temperature in the furnace can be between approximately 200 to 600 degrees Celsius. In addition, the temperature can be increased at a rate between of 0.1 and ∞ (infinity) degrees Celsius per minute to between 200 and 600 degrees Celsius. Alternatively, the furnace temperature can be held at between 200 and 600 degrees Celsius for any time between 0.5 and 12 hours.

In accordance with an exemplary embodiment, the flow of the carrier gas is stopped and the film is cooled to approximately 20 degrees Celsius.

In accordance with a further exemplary embodiment, the method for silylating pure silica zeolite films further includes adding a solvent, such as 1-butanol, and the silylating agent, such as hexamethyldisilazane (HMDS), to the PSZ nanoparticle suspension and spinning the suspension onto the substrate. The ratio of solvent to nanoparticle suspension to silylation agent preferably has a mass ratio of 0-20:0-20:0-20. Alternatively, a solvent, such as 1-butanol, and an alkoxysilane, such as TEOS, can be added to the nanoparticle suspension and spinning the suspension onto the substrate. In accordance with an exemplary embodiment, the alkoxysilane to solvent to PSZ nanoparticle suspension with a mass ratio of 0-20:0-20:0-20, alkoxysilane:solvent:nanoparticle suspension. Alternatively, the solvent is an alcohol such as 1-butanol, anhydrous, 99.8%.

In accordance with an exemplary embodiment, the method for silylating pure silica zeolite films further comprises placing the film in a furnace at a temperature between 20 and 150 degrees Celsius for between 0 and 48 hours. The film can be placed in a furnace at a temperature between 20 and 150 degrees Celsius and flowing a carrier gas, such as nitrogen, argon, or helium, through the furnace for any time between 0 and 48 hours.

In accordance with an exemplary embodiment, the PSZ nanoparticle suspension can be spun onto a substrate between 300 and 6000 revolutions per minute (rpm) for between 10 and 180 seconds (s) with an acceleration between 100 and 6000 rpm/s on a spin coater.

In accordance with an exemplary embodiment, the porous silica film is a pure zeolite film (PSZ) nanoparticle suspension, and the nanoparticle suspension is synthesized by: adding tetrabutylammonium hydroxide (TBAOH) to a silica source, such as tetraethylorthosilicate (TEOS), Ludox, and/or fumed silica, in a bottle with or without stirring; adding water; stirring the solution at room temperature or under heat for 0 to 10 days; moving the solution into a preheated convection oven between 50 and 100 Celsius (° C.) with stirring for 1 to 5 days; transferring the solution to Teflon®-lined autoclaves; and placing the autoclaves into a preheated convection oven between 100 and 130 Celsius (° C.) for 0.1 to 7 days with or without stirring.

It can be appreciated that in accordance with an exemplary embodiment, the method for silylating pure silica zeolite films includes the following parameters: the starting temperature of the furnace is preferably between approximately 0 to 600 degrees Celsius, and more preferably about 10 to 100 degrees Celsius, and most preferably about 25 degrees Celsius. In addition, the temperature (or ramp rate) can be increased at a rate of between 0.1 and ∞ (infinity) degrees Celsius per minute, more preferably approximately 0.5 to 10 degrees Celsius per minute, and most preferably about 1 degree Celsius per minute. In accordance with an exemplary embodiment, the bake temperature within the furnace is 20 to 150 degrees Celsius, more preferably about 80 to 120 degrees Celsius, and most preferably about 113 degrees Celsius. In addition, the silylation temperature is preferably 200 to 600 degrees Celsius, more preferably 300 to 500 degrees Celsius, and most preferably 400 degrees Celsius. The bake hold time in accordance with a preferred embodiment, is 0 to 48 hours, more preferably 12-36 hours and most preferably approximately 24 hours.

In accordance with an exemplary embodiment, the silylation hold time is preferably approximately 0.5 to 12 hours, more preferably 1 to 6 hours, and most preferably 2 hours. In accordance with an exemplary embodiment, the butanol:nanoparticle suspension:silylation agent has a preferred ration of 0-20:0-20:0-20, more preferably 5-15:5-15:0-5, and most preferably 9.5:9.5:1. The alkoxysilane:solvent:nanoparticle suspension has a preferred ratio of 0-20:0-20:0-20, more preferably 0-1:0-5:0-5, and most preferably x:1:1, where x is 0, 0.06, 0.13, 0.20, or 0.27.

In accordance with another exemplary embodiment, the method includes a spin rate of approximately 300 to 6000 rpm, more preferably approximately 1000 to 4000 rpm, and most preferably approximately 3000 rpm. The spin time is preferably 10 to 180 seconds, more preferably 10 to 60 seconds and most preferably approximately 30 seconds. In addition, the spin acceleration is approximately 100 to 6000 rpm/s, more preferably 500 to 2000 rpm/s, and most preferably approximately 1275 rpm/s.

In accordance with an exemplary embodiment, the suspension aging time is approximately 0 to 10 days, more preferably 0 to 2 days, and most preferably 1 day, and wherein the 1st stage temperature is 50 to 100 degrees Celsius, more preferably 70 to 90 degrees Celsius, and most preferably 80 degrees Celsius; the 1st stage time being 1 to 5 days, more preferably 1 to 3 days, and most preferably 2 days; 2nd stage temperature of approximately 100 to 130 degrees Celsius, more preferably 110 to 120 degrees Celsius, and most preferably approximately 114 degrees Celsius; and 2nd stage time of 0.1 to 7 days, more preferably 0.5 to 3 days, and most preferably 1 day.

### EXAMPLES

### Trimethylchlorosilane (TMCS)

In accordance with an exemplary embodiment, a PSZ MEL nanoparticle suspension was synthesized by adding 19.97 g of tetrabutylammonium hydroxide (TBAOH, 55% aqueous solution) to 30 g (grams) of tetraethylorthosilicate (TEOS, 98%) in a polypropylene bottle under stirring. Then, 21.49 g of double-deionized water was added, and the solution was stirred at room temperature for one day. The mixture was moved into a preheated convection oven at 80° C. with stirring for two days and was subsequently transferred to Teflon®-lined autoclaves. The autoclaves were placed into a preheated convection oven at 114° C. for 24 h (hours) with no stirring. Butanol (1-butanol, anhydrous, 99.8%) was added at a mass ratio of 1:1 to the nanoparticle suspension and this solution was spun onto silicon substrates at 3000 rpm for 30 s (seconds) with an acceleration of 1275 rpm/s (revolution per minute per second) on a spin coater.

The films were placed into a tubular furnace at 28° C. Nitrogen as a carrier gas flowed through a bubbler at room temperature containing 1:1 (by mass) toluene (99.8%):TMCS (98%). The flow rate through the bubbler was about 3 L/h (liters per hour). The temperature in the furnace was increased at a rate of 1° C./min to 400° C. and was then held at 400° C. for 2 hour. Then, the system was closed and the nitrogen flow was stopped. The films were cooled to 28° C.

Hexamethyldisilazane (HMDS)

In accordance with another exemplary embodiment, a PSZ MEL nanoparticle suspension was synthesized by adding 19.97 g of TBAOH to 30 g of TEOS in a polypropylene bottle under stirring. Then, 21.49 g of double-deionized water was added, and the solution was stirred at room temperature for one day. The mixture was moved into a preheated convection oven at 80° C. with stirring for two days and was subsequently transferred to Teflon®-lined autoclaves. The autoclaves were placed into a preheated convection oven at 114° C. for 24 hours with no stirring. Butanol was added at a mass ratio of 1:1 to the nanoparticle suspension and this solution was spun onto silicon substrates at 3000 rpm for 30 seconds with an acceleration of 1275 rpm/s on a spin coater.

The films were placed into a tubular furnace at 28° C. Nitrogen as a carrier gas flowed through a bubbler at room temperature containing 1:1 (by mass) toluene:HMDS. The flow rate through the bubbler was about 3 liters per hour (L/h). The temperature in the furnace was increased at a rate of 1° C./min to 400° C. and was then held at 400° C. for 2 hours. Then, the system was closed and the nitrogen flow was stopped. The films were cooled to 28° C.

Presilylated with HMDS (Presilylated)

In accordance with a further embodiment, a PSZ MEL nanoparticle suspension was synthesized by adding 19.97 g of TBAOH to 30 g of TEOS in a polypropylene bottle under stirring. Then, 21.49 g of double-deionized water was added, and the solution was stirred at room temperature for one day. The mixture was moved into a preheated convection oven at 80° C. with stirring for two days and was subsequently transferred to Teflon®-lined autoclaves. The autoclaves were placed into a preheated convection oven at 114° C. for 24 hour with no stirring. Butanol and HMDS was added at a mass ratio of 9.5:9.5:1 butanol:nanoparticle suspension:HMDS and this solution was spun onto silicon substrates at 3000 rpm for 30 seconds with an acceleration of 1275 rpm/s on a spin coater.

The films were placed into a tubular furnace at 28° C. Nitrogen as a carrier gas was flowed through a bubbler at room temperature containing 1:1 (by mass) toluene:HMDS. The flow rate through the bubbler was about 3 Liters per hour (L/h). The temperature in the furnace was increased at a rate of 1° C./min to 400° C. and was then held at 400° C. for 2 hours. Then, the system was closed and the nitrogen flow was stopped. The films were cooled to 28° C.

Hexamethyldisilazane with TEOS—Air Baked (HTA)

In accordance with another embodiment, a PSZ MEL nanoparticle suspension was synthesized by adding 19.97 g of TBAOH to 30 g of TEOS in a polypropylene bottle under stirring. Then, 21.49 g of double-deionized water was added, and the solution was stirred at room temperature for one day. The mixture was moved into a preheated convection oven at 80° C. with stirring for two days and was subsequently transferred to Teflon®-lined autoclaves. The autoclaves were placed into a preheated convection oven at 114° C. for 24 hour with no stirring. TEOS, butanol, and the nanoparticle suspension were mixed at a mass ratio of x:1:1 TEOS:butanol:nanoparticle suspension, where x is 0, 0.06, 0.13, 0.20, or 0.27 (or with TEOS percentages of 0, 3, 6, 9, or 12% of the total solution) and aged for 12 hours. This solution was then spun onto silicon substrates at 3000 rpm for 30 seconds with an acceleration of 1275 rpm/s on a spin coater.

The films were placed into a tubular furnace in air at 113° C. and the temperature was held at 113° C. for 24 hours. Then, nitrogen as a carrier gas flowed through a bubbler at room temperature containing 1:1 (by mass) toluene:HMDS. The flow rate through the bubbler was about 3 Liters per hour (L/h). The temperature in the furnace was increased at a rate of 1° C./min to 400° C. and was then held at 400° C. for 2 hours. Then, the system was closed and the nitrogen flow was stopped. The films were cooled to 28° C.

Hexamethyldisilazane with TEOS—N₂ Baked (HTN)

In accordance with a further embodiment, a PSZ MEL nanoparticle suspension was synthesized by adding 19.97 g of TBAOH to 30 g of TEOS in a polypropylene bottle under stirring. Then, 21.49 g of double-deionized water was added, and the solution was stirred at room temperature for one day. The mixture was moved into a preheated convection oven at 80° C. with stirring for two days and was subsequently transferred to Teflon®-lined autoclaves. The autoclaves were placed into a preheated convection oven at 114° C. for 24 hours with no stirring. TEOS, butanol, and the nanoparticle suspension were mixed at a mass ratio of x:1:1 TEOS:butanol:nanoparticle suspension, where x is 0, 0.06, 0.13, 0.20, or 0.27 (or with TEOS percentages of 0, 3, 6, 9, or 12% of the total solution) and aged for 12 hours. This solution was then spun onto silicon substrates at 3000 rpm for 30 seconds with an acceleration of 1275 revolutions per minute per second (rpm/s) on a spin coater.

The films were placed into a tubular furnace at 113° C. Nitrogen flowed through the tubular furnace and the temperature was held at 113° C. for 24 hours. Then, nitrogen as a carrier gas flowed through a bubbler at room temperature containing 1:1 (by mass) toluene:HMDS. The flow rate through the bubbler was about 3 Liters per hour (L/h). The temperature in the furnace was increased at a rate of 1° C./min to 400° C. and was then held at 400° C. for 2 hours. Then, the system was closed and the nitrogen flow was stopped. The films were cooled to 28° C.

Evaluation of Silylated Films

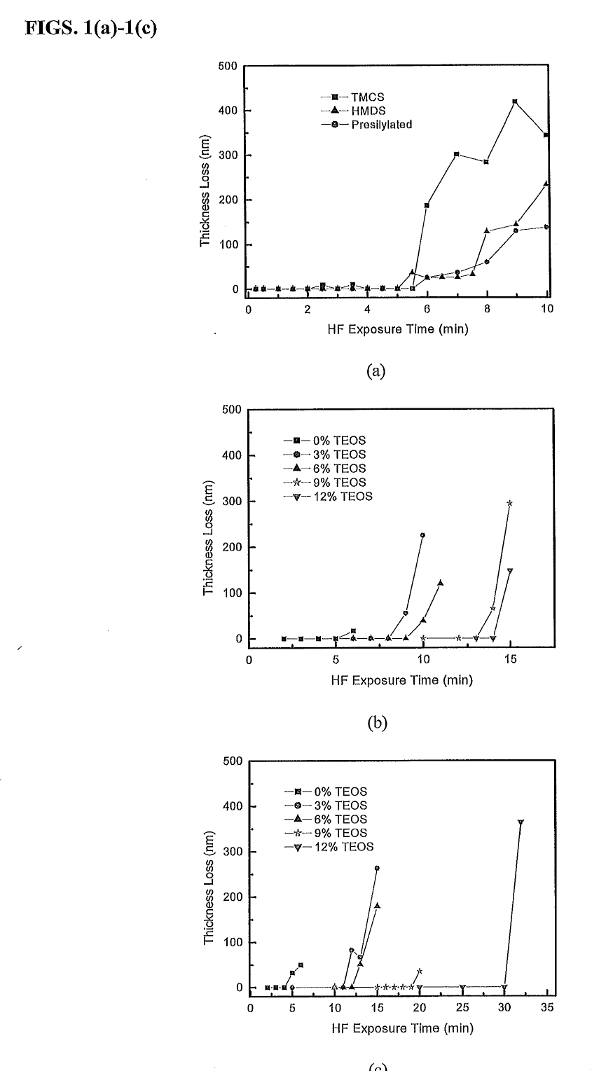

FIG. 1(a) shows the HF resistance of TMCS, HMDS, and Presilylated films, FIG. 1(b) shows the HF resistance of the HTA films, and FIG. 1(c) shows the HF resistance of the HTN films. The film thickness was measured before and after exposure to 0.48% HF by spectroscopic ellipsometry. For FIG. 1(a), the Presilylated films exhibit the best HF resistance, followed by the HMDS films and then the TMCS films. For both the HTA and HTN films, the HF resistance increases with increasing TEOS concentration. It can be appreciated that HTN films have more HF resistance than HTA films; HTN films with 12% TEOS can last up to 30 minutes in HF before the films begin to etch away.

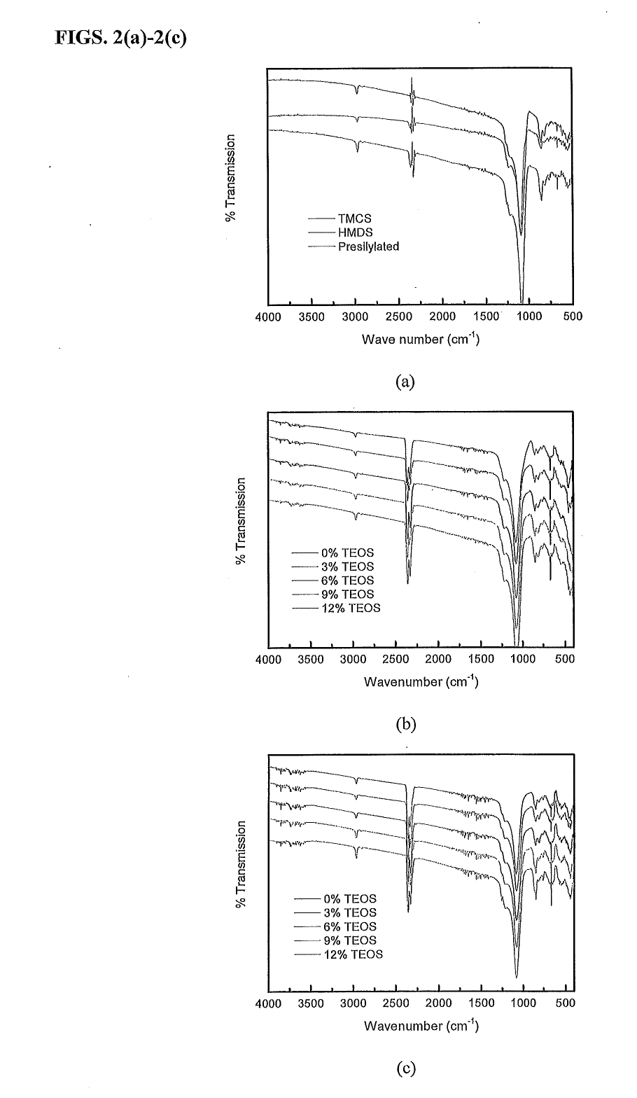

FIG. 2(a) shows the Fourier-transform infrared spectroscopy spectra for TMCS, HMDS, and Presilylated films, FIG. 2(b) shows the FTIR spectra for the HTA films, and FIG. 2(c) shows the FTIR spectra for the HTN films. Isolated hydroxyl groups appear between 3742-3746 cm⁻¹. Asymmetric and symmetric —CH₃ stretching occurs at 2965-2967 cm⁻¹ and 2901-2902 cm⁻¹, respectively, and Si—CH₃ deformation and rocking appear as peaks between 1255-1280 cm⁻¹ and 840-850 cm⁻¹. The TMCS, HMDS, and Presilylated films exhibit methyl peaks and no isolated hydroxyl peaks. It can be appreciated that this shows that the isolated hydroxyls have been replaced with methyl groups. Both HTA and HTN films also show significant methyl peaks.

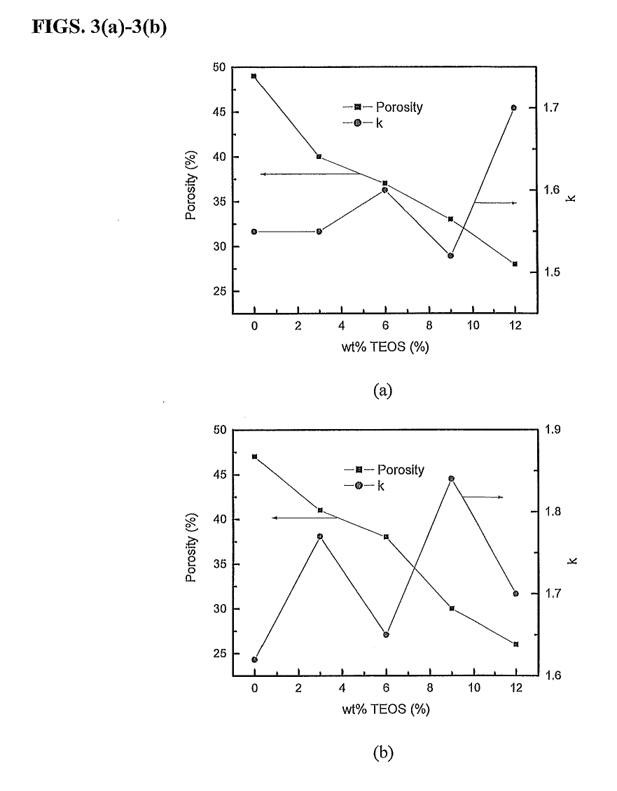

FIG. 3(a) shows how the porosity and k value of the HTA films varies with increasing TEOS content and FIG. 3(b) shows how the porosity and k value of the HTN films varies with increasing TEOS content. Porosity decreases with increasing TEOS concentration for both sets of films. The k values of the HTA films are between 1.5 and 1.7, while the HTN films have k values between 1.6 and 1.9.

The properties of all the films are summarized in Table 1. Adding TEOS to the suspension before the spin-on process increases both the reduced modulus and the hardness values, as seen by the higher Eᵣ and H values of the HTA and HTN films over the TMCS, HMDS, and Presilylated films.

TABLE 1
Physical properties of all the films.

| | % | porosity | | Eᵣ | | HF resistance |
|---|---|---|---|---|---|---|
| film | TEOS | (%)^{a} | k^{b} | (GPa)^{c} | H (GPa)^{c} | (min)^{d} |
| TMCS | — | 63 | 1.63 | 2.0 ± 0.2 | 0.16 ± 0.01 | 5.5 |
| HMDS | — | 51 | 1.57 | 3.3 ± 0.2 | 0.25 ± 0.01 | 5 |
| Presilylated | — | 54 | 1.59 | 3.8 ± 0.2 | 0.32 ± 0.02 | 5.5 |
| HTA | 0 | 49 | 1.55 | 5.6 ± 0.4 | 0.47 ± 0.03 | 5 |
| HTA | 3 | 40 | 1.55 | 12.1 ± 0.9 | 0.96 ± 0.15 | 8 |
| HTA | 6 | 37 | 1.60 | 12.4 ± 1.0 | 1.09 ± 0.10 | 9 |
| HTA | 9 | 33 | 1.52 | 20.0 ± 1.3 | 1.79 ± 0.13 | 13 |
| HTA | 12 | 28 | 1.70 | 15.6 ± 0.6 | 1.53 ± 0.07 | 14 |
| HTN | 0 | 47 | 1.62 | 4.6 ± .2 | 0.48 ± 0.05 | 4 |
| HTN | 3 | 41 | 1.77 | 7.6 ± 0.2 | 0.62 ± 0.02 | 11 |
| HTN | 6 | 38 | 1.65 | 11.4 ± 1.0 | 1.00 ± 0.04 | 12 |
| HTN | 9 | 30 | 1.84 | 11.2 ± 1.0 | 1.02 ± 0.07 | 19 |
| HTN | 12 | 26 | 1.70 | 7.9 ± 0.6 | 0.62 ± 0.03 | 30 |

^{a}Porosity was measured by spectroscopic ellipsometry using silica with void space as a model.
^{b}k values were measured as-synthesized.
^{c}E and H values were measured by nanoindentation with a cube corner tip.
^{d}Film thickness was measured by spectroscopic ellipsometry before and after exposure to 0.48% HF.
The resistance time was the time in which the film thickness did not change.

It will be understood that the foregoing description is of the preferred embodiments, and is, therefore, merely representative of the article and methods of manufacturing the same. It can be appreciated that many variations and modifications of the different embodiments in light of the above teachings will be readily apparent to those skilled in the art. Accordingly, the exemplary embodiments, as well as alternative embodiments, may be made without departing from the spirit and scope of the articles and methods as set forth in the attached claims.

What is claimed is:

1. A method of silylating porous silica films comprising:
preparing a porous silica film; and
grafting the film with a hydrophobic functional group while annealing the film.

2. The method of claim 1, wherein the porous silica film is a sol-gel silica film, a mesoporous silica film, an in situ crystallized polycrystalline zeolite film, or a zeolite spin-on film.

3. The method of claim 1, wherein the hydrophobic functional group is trimethylchlorosilane (TMCS); dimethyldichlorosilane; methyltrichlorosilane; alkylchlorosilanes, such as (CH₃(CH₂)ₙ)ₓSiCl₄₋ₓ, where x is 1, 2, or 3; alkoxychlorosilanes; hexamethyldisilazane (HMDS), and/or aminosilanes.

4. The method of claim 1, wherein the steps of grafting and annealing the film are performed simultaneously, which imparts hydrofluoric acid resistance and reduces moisture adsorption to the film.

5. The method of claim 1, wherein the porous silica film is prepared by spin-on using a pure-silica zeolite (PSZ) nanoparticle suspension, which is prepared by synthesizing tetrabutylammonium hydroxide, tetraethylorthosilicate, and double-deionized water.

6. The method of claim 5, further comprising adding a solvent, such as 1-butanol, to the nanoparticle suspension and spinning the suspension onto a substrate.

7. The method of claim 6, further comprising:
placing the film in a furnace at a temperature between 0 and 600 degrees Celsius; and
flowing a carrier gas through a bubbler at room temperature containing a solvent, such as toluene, and the silylating agent.

8. The method of claim 7, wherein the carrier gas is nitrogen, argon, and/or helium.

9. The method of claim 7, further comprising increasing the temperature in the furnace to between 200 to 600 degrees Celsius.

10. The method of claim 9, further comprising increasing the temperature at a rate between of 0.1 and ∞ (infinity) degrees Celsius per minute to between 200 and 600 degrees Celsius.

11. The method of claim 10, further comprising holding the furnace temperature between 200 and 600 degrees Celsius for between 0.5 and 12 hours.

12. The method of claim 11, further comprising stopping the flow of the carrier gas and cooling the film to approximately 20 degrees Celsius.

13. The method of claim 5, further comprising adding a solvent, such as 1-butanol, and the silylating agent, such as hexamethyldisilazane (HMDS), to the nanoparticle suspension and spinning the suspension onto the substrate.

14. The method of claim 13, wherein the ratio of solvent to nanoparticle suspension to silylation agent has a mass ratio of 0-20:0-20:0-20.

15. The method of claim 14, further comprising placing the film in a furnace at a temperature between 0 and 600 degrees Celsius, and flowing a carrier gas, such as nitrogen, argon, or helium, through a bubbler at room temperature containing a solvent, such as toluene, and the silylating agent.

16. The method of claim 5, further comprising adding a solvent, such as 1-butanol, and an alkoxysilane, such as TEOS, to the nanoparticle suspension and spinning the suspension onto the substrate.

17. The method of claim 16, wherein the alkoxysilane to solvent to nanoparticle suspension has a mass ratio of 0-20:0-20:0-20, alkoxysilane:solvent:nanoparticle suspension.

18. The method of claim 17, further comprising placing the film in a furnace at a temperature between 20 and 150 degrees Celsius for between 0 and 48 hours.

19. The method of claim 17, further comprising placing the film in a furnace at a temperature between 20 and 150 degrees Celsius and flowing a carrier gas, such as nitrogen, argon, or helium, through the furnace for between 0 and 48 hours.

20. The method of claim 19, further comprising flowing a carrier gas, such as nitrogen, argon, or helium, as a carrier gas through a bubbler at room temperature containing a solvent, such as toluene and a silylating agent.

21. The method of claim 20, further comprising increasing the temperature in the furnace to between 200 and 600 degrees Celsius.

22. The method of claim 21, further comprising increasing the temperature at a rate between 0.1 and 00 (infinity) degrees Celsius per minute to between 200 and 600 degrees Celsius.

23. The method of claim 6, further comprising spinning the nanoparticle suspension onto the substrate between 300 and 6000 revolutions per minute (rpm) for between 10 and 180 seconds (s) with an acceleration between 100 and 6000 rpm/s on a spin coater.

24. A method of silylating pure zeolite films comprising:
preparing a pure zeolite film (PSZ) nanoparticle suspension, wherein the nanoparticle suspension is synthesized by:
adding tetrabutylammonium hydroxide (TBAOH) to a silica source, such as tetraethylorthosilicate (TEOS), Ludox, and/or fumed silica, in a bottle with or without stirring;
adding water;
stirring the solution at room temperature or under heat for 0 to 10 days;
moving the solution into a preheated convection oven between 50 and 100° C. with stirring for 1 to 5 days;
transferring the solution to Teflon®-lined autoclaves; and
placing the autoclaves into a preheated convection oven between 100 and 130° C. for 0.1 to 7 days with or without stirring; and
grafting the film with a hydrophobic functional group while annealing the film.

25. The method of claim 6, wherein the solvent is an alcohol such as 1-butanol, anhydrous, 99.8%.

26. The method of claim 1, wherein the method does not include a post-annealing silylation step.

27. The method of claim 1, wherein the porous silica film is a zeolite structural type, such as MFI, MEL, FAU, LTA, TSC, OBW, or BEA.

28. A zeolite film prepared by the method as described in claim 1.
